(19) United States
(12) Patent Application Publication
(10) Pub. No.: US 2020/0120163 A1
(43) Pub. Date: Apr. 16, 2020

(54) MANAGING DATA AND PERSONIFICATION OF IOT DEVICES IN MULTIPLE NETWORKS

(71) Applicant: THINGIFY PRIVATE LIMITED, Gurugram (IN)

(72) Inventors: Rishi GARGI, Gurgaon (IN); Vinay SOLANKI, Gurgaon (IN)

(73) Assignee: THINGIFY PRIVATE LIMITED, Gurugram (IN)

(21) Appl. No.: 16/600,306

(22) Filed: Oct. 11, 2019

(30) Foreign Application Priority Data
Oct. 12, 2018 (IN) 201811038894

(51) Int. Cl. H04L 29/08; G06F 9/451; G06N 3/04; G06N 3/08; H04L 12/24

(52) U.S. Cl. CPC H04L 67/125; G06F 9/451; H04L 67/22; G06N 3/08; H04L 41/22; G06N 3/0454

(57) ABSTRACT

The present invention provides managing data and personification of IOT devices operating in multiple networks or applications. The system for managing data includes a plurality of IOT devices configured for data capture and communication, a network interface configured to communicate with one or more remote systems in communication with the plurality of IOT devices, at least one controller in communication with the plurality of IOT devices for controlling and managing the captured data, at least one memory to store instructions or rules or protocols, and at least one processor configured to execute instructions based on the stored rules wherein the processor is associated with a cognitive artificial intelligence engine configured for collating the captured data from the plurality of IOT devices to generate data patterns based on machine learning models and natural language processing (NLP) models.

### FIELD OF THE INVENTION

The present invention relates to machine learning and Internet of things (IOT). More particularly, the invention relates to system and method for managing data in IOT networks or applications.

### BACKGROUND

Multiple types of devices are connected over a network by The Internet of Things (IoT). The devices in the IOT can be a monitoring camera, a sensor device, or anything that communicates data over an Internet connection. Devices in the IOT usually have a way to connect to the Internet to report data to other devices and request/receive information from other devices. Devices may connect to the Internet in many ways, such as through a fixed Wi-Fi connection, a Bluetooth connection, a direct wireless network connection (e.g., 3G, 4G or 5G standards), or a proprietary connection to a wireless network.

IOT finds applications in various places including home automation, or smart homes, that enhance quality of life of the users. More specifically, a home automation system enables centralized control of lighting, heating, ventilation, and air conditioning appliances, and other systems, thus providing improved convenience, comfort, energy efficiency, and security. Some automation systems provide a way to automate the control of a device based on timed or environmental factors, such as in an HVAC unit or a sprinkler system. However, these typical automation systems provide automated control for an individual type of appliance, and the different automation systems do not interface with one another to provide a complete home automation solution.

Many automation technologies or other IOT based technologies are implemented using specially designed control and monitor devices that communicate with one another using a dedicated communication protocol. Moreover, the devices and systems of existing set-up unable to operate and manage multiple IoT solutions which are disparate, incompatible, and complex that leads to slow adoption of IOT as a technology across home, buildings, cities, enterprises and service industry.

Imbalance between complexity and value addition in comparison to affordability of IOT solution makes it difficult to realize the potential of IOT based technologies. Easy to use or setup solutions are not affordable or economical and less expensive solutions are complex to setup and use and hence offer low value addition.

In view of the above, there exists a need of improved systems and methods that overcome the shortcomings associated with existing technologies and prior arts.

### SUMMARY OF THE INVENTION

Accordingly, the present invention provides a method for managing data in IOT networks or applications. The method comprises the steps of creating a user interface configured to communicate through applications associated with multiple IOT devices, in response to receiving instructions for analysis of data, collating data from across the multiple IOT devices using an artificial intelligence engine, and deriving a plurality of data patterns wherein a plurality of machine learning models and natural language processing (NLP) models enable generation of data patterns using an artificial intelligence engine thereby providing recommendation to a user based on the data patterns.

In an embodiment, the present invention provides a system for managing data in IOT networks or applications. The system includes a plurality of IOT devices configured for data capture and communication, a cognitive network layer comprising, a network interface configured to communicate with one or more remote systems in communication with the plurality of IOT devices, at least one controller in communication with the plurality of IOT devices for controlling and managing the captured data, at least one memory to store instructions or rules or protocols, and at least one processor configured to execute instructions based on the stored rules wherein the processor is associated with an artificial intelligence engine configured for collating the captured data from the plurality of IOT devices to generate data patterns based on machine learning models and natural language processing (NLP) models.

In an embodiment, the present invention provides a computer-readable non-transitory storage medium storing executable program instructions for managing data in Internet of Things (IOT) networks which when executed by a computer cause the computer to perform operations as described above.

In an embodiment, the present invention provides a method for personification of IOT devices interfaced to operate with a single platform. The method includes collating data captured by multiple IOT devices, learning a user behavior through the collated data using neural networks, and deriving a plurality of data patterns for personification of IOT devices wherein a plurality of machine learning models and natural language processing (NLP) models enable generation of data patterns using a cognitive artificial intelligence engine thereby providing recommendation to a user based on the data patterns.

In an embodiment, the single platform enables generation of data patterns for personification of IOT devices operating with incompatible applications

In an advantageous aspect, the present invention builds a common platform to operate multiple IOT devices or IOT solutions seamlessly and in a simplified way thereby making them inter operable through a common interface. The present invention reduces complexity in adoption and add convenience there by increasing the reach and scale for IOT. The present invention builds intelligence around the data and trends captured from IoT solutions or IoT devices and creates a personalization for each user.

### DESCRIPTION OF THE DRAWING

FIG. 1 shows a block diagram with system components configured for managing data in multiple IOT applications in accordance with an embodiment of the present invention.

FIG. 1a shows a flow diagram with system components configured for managing data in IOT networks in accordance with an embodiment of the present invention.

FIG. 2 shows a flow diagram with system components configured for executing user instruction of turning on light in home automation in accordance with an embodiment of the present invention.

FIG. 2a a flow diagram with system components configured for executing user instruction of turning on light in home automation after a time delay in accordance with an embodiment of the present invention.

FIG. 2b shows a process flow for execution of turning on light in home automation after a time delay in accordance with an embodiment of the present invention.

FIG. 2c shows a process flow for execution of turning on light in home automation with detection from IOT devices in accordance with an embodiment of the present invention.

FIG. 3 shows a flow diagram with system components configured for executing user instruction of operating air-conditioning in automation environment in accordance with an embodiment of the present invention.

### DESCRIPTION OF THE INVENTION

Various embodiment of the present invention provides system and method for managing data in IOT networks. The following description provides specific details of certain embodiments of the invention illustrated in the drawings to provide a thorough understanding of those embodiments. It should be recognized, however, that the present invention can be reflected in additional embodiments and the invention may be practiced without some of the details in the following description.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “API,” “layer,” “platform” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

Embodiments described herein will refer to plan views and/or cross-sectional views by way of ideal schematic views. Accordingly, the views may be modified depending on simplistic assembling or manufacturing technologies and/or tolerances. Therefore, example embodiments are not limited to those shown in the views but include modifications in configurations formed on basis of assembling process. Therefore, regions exemplified in the figures have schematic properties and shapes of regions shown in the figures exemplify specific shapes or regions of elements, and do not limit the various embodiments including the example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to system and method for managing data in IOT networks or applications and personification of IOT devices.

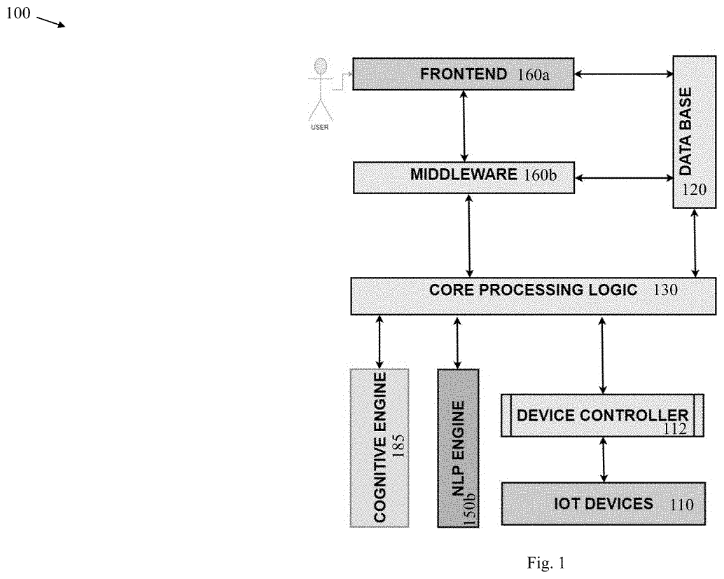

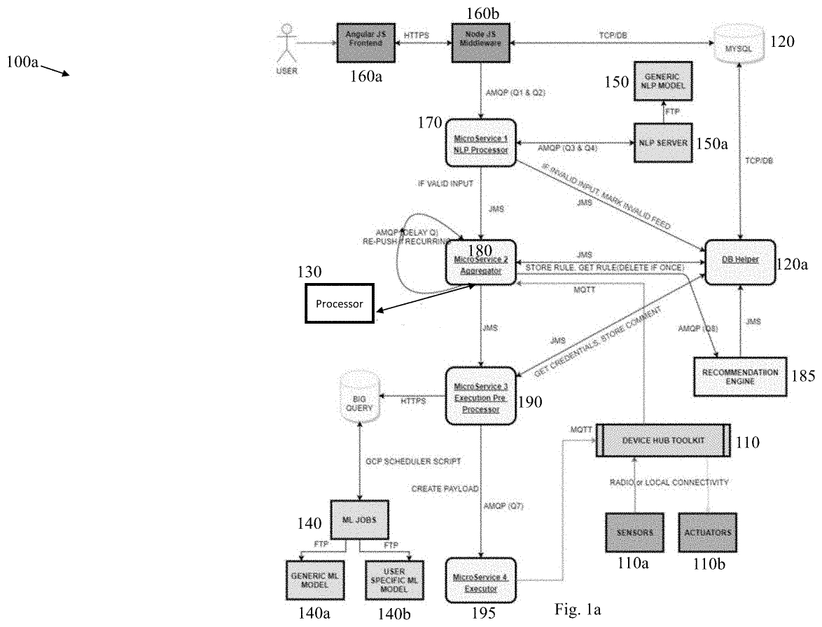

Referring FIG. 1 and la, system (100, 100a) for managing data in IOT networks or applications is provided in accordance with an embodiment of the present invention. The system (100, 100a) includes a plurality of IOT devices 110 configured for data capture and communication, a network interface configured to communicate with one or more remote systems in communication with the plurality of IOT devices 110, at least one controller 112 in communication with the plurality of IOT devices 110 for controlling and managing the captured data; at least one memory 120 to store instructions or rules or protocols, and at least one processor 130 configured to execute instructions based on the stored rules where the processor 130 is associated with a cognitive artificial intelligence engine 185 configured for collating the captured data from the plurality of IOT devices to generate data patterns based on machine learning models 140 and natural language processing (NLP) models (150).

In a related embodiment, the cognitive AI engine 185 of the present invention uses neural networks to learn the user's behavior and extract the data patterns from it. The data patterns are further used to personify the system for the user.

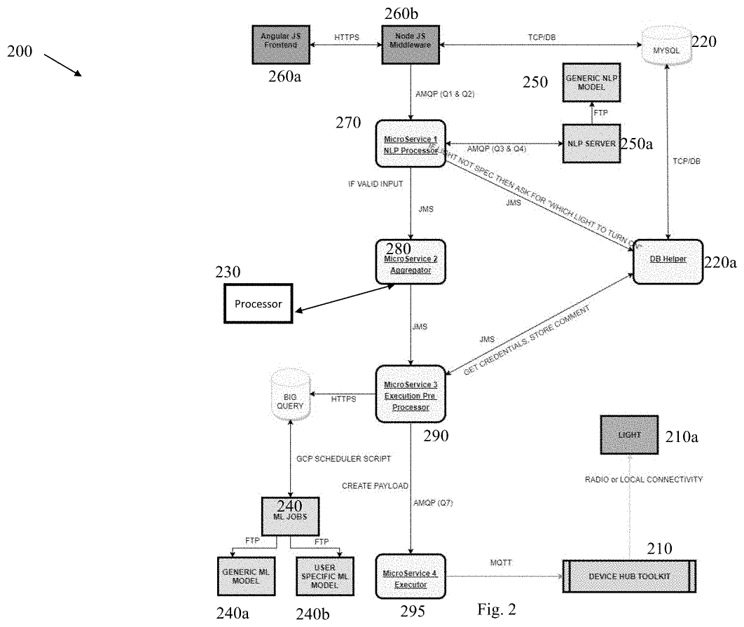

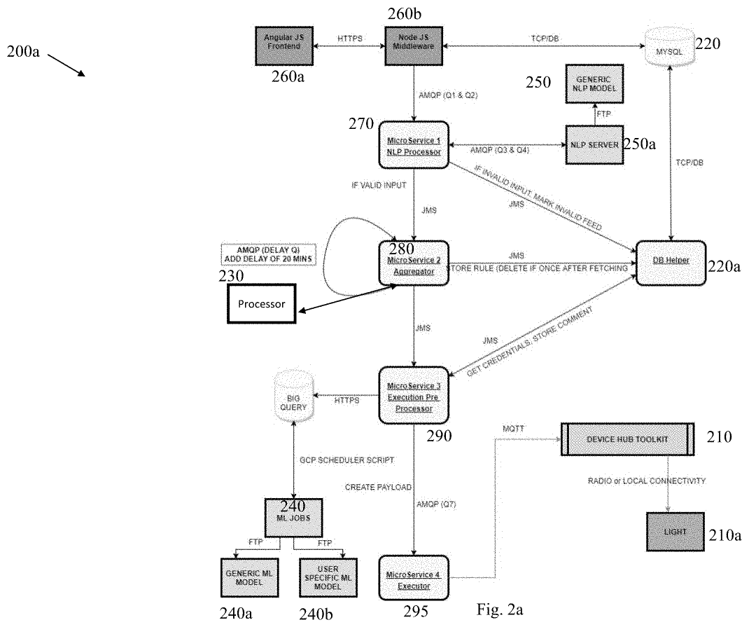

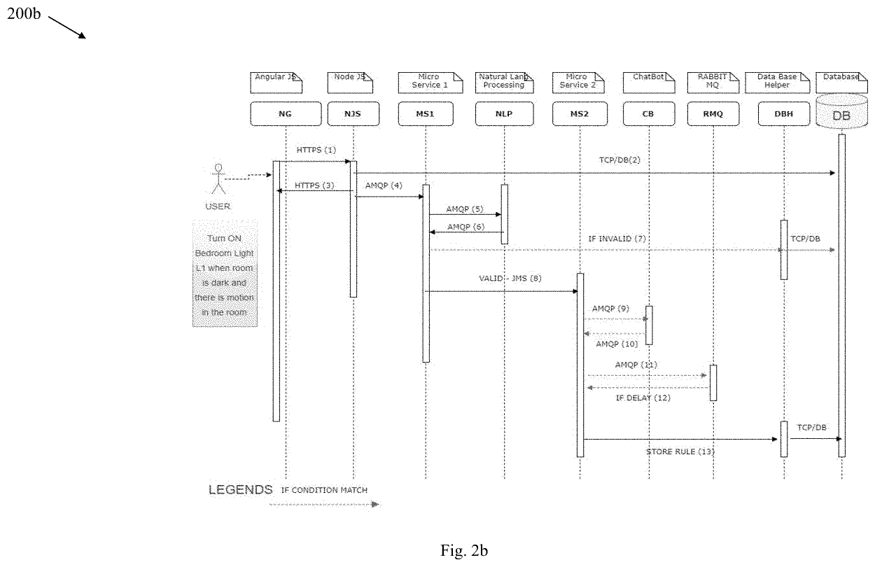

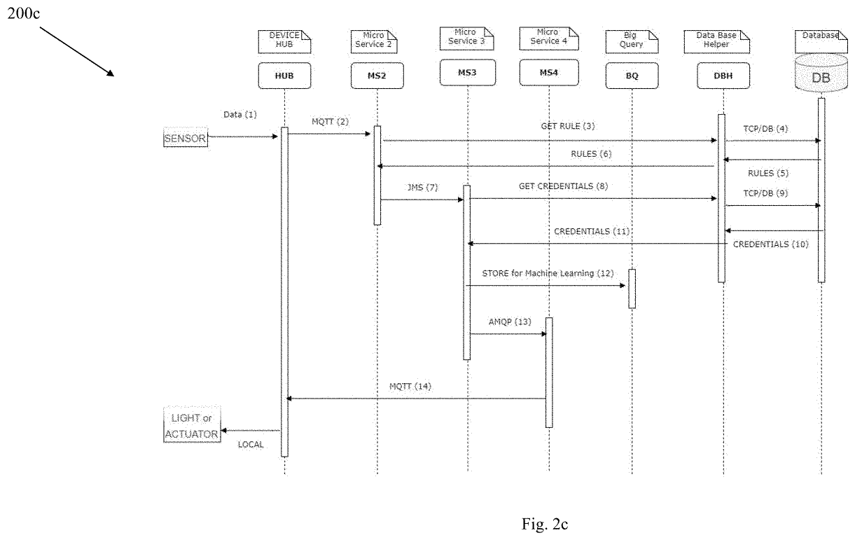

Referring to FIG. 1, 1a, FIG. 2, FIG. 2a the system (100, 100a) of the present invention is provided in accordance with an exemplary embodiment. The system (100, 200, 200a) includes an AngularJS Frontend (160a, 260a) that supports both web and mobile frontend, a NodeJS Middleware (160b, 260b) that acts as middle interface layer and pass through a communication layer, a NLP Microservice (170, 270) to manage NLP commands and inputs, a NLP Parsing Server (150a, 250a) to interpret user commands both in text and voice, a NLP engine 150b, an Aggregator Microservice (180, 280) to aggregate multiple activities, a recommendation Engine 185, a pre-Processor Microservice (190, 290), an Executor Microservice (195, 295), plurality of machine learning Jobs (140, 240) including Generic ML model (140a, 240a) and user specific ML model (140b, 240b) and a device Hub Toolkit (110, 210) to manage the connectivity with sensors 110a and actuators 110b.

References made to implementation of various functions by means of annotation software built with languages using HTML, CSS, Javascript, JQuery, EmberJS, AngularJS, scikit-learn, google tensor flow, messaging queues and various cloud services, NodeJS, XML, HTMLS, java, C, C+, Csharp, python, Django, Natural Language Toolkit (NLTK) in python, Open NLP in Solr, Solr/Lucene, Tesseract Optical Character Recognition, and many other languages and software packages are for reference. It shall be understood to a person skilled in the art to carry out the invention with different languages without departing from the scope of the present invention.

In an example embodiment as depicted from FIGS. 2, 2a, 2b and 2c a use case of the system where a user is setting a rule to “turn ON the bedroom light (210a) when room is dark and there is some motion in the room” is provided.

In an embodiment, the system components capture the users input from the frontend 260a app (browser or mobile app) through AngularJS and then using NodeJS middle ware 260b and some microservices 270 store the rule in the database. The system (200a) enables the option if the user wants to execute some command after a certain delay (FIG. 2a). In this case using Natural language processing 250 and Java based micro services 270 user instructs the platform to turn on the bedroom light 210a after a delay of “x” duration. The system can sense when room is dark (captured through luminosity sensor) or there is someone in the room (captured through a motion sensor).

In another embodiment, luminosity and motion sensor data is captured, then using the DB the platform retrieves and checks for the stored rules. Since, the condition here is assumed to meet the rule set by the user earlier, the system using the device HUB instruct the bedroom light to turn ON through the actuator (which is typically a relay).

In an embodiment, the system of the present invention stores a set of rules or protocols in a memory to be executed for generating data patterns.

In another embodiment, the present invention analyzes a user behavior data.

In an exemplary embodiment, artificial intelligence (AI) engine of the present invention is a recommendation engine configured to analyze user behavior based on data gathered from the multiple IOT devices and provide recommendation to end user for next actions. This cognitive AI engine of the present invention uses neural networks to learn the user's behavior and extract useful patterns from it, which are further used to personify the system for the user. The engine learns from the user's sequence of doing things according to the external factors and generates the patterns for the same which are then used to recommend the next actions. Leveraging neural networks, machine learning and natural language processing the system recommends the best behavior for device usage and also detect anomalies.

In an embodiment, multiple IOT devices are operated based on user instructions.

In an exemplary embodiment, the present invention analyzes various user behaviors. The system enables a user to allow another user to operate their devices, like giving access to front door camera of the house to a neighbor when on vacation or to intrusion detection sensors. This access is given to the neighbor for a limited time period.

In an embodiment the present invention includes a user interface configured for interacting with multiple IOT devices through a single application.

In an embodiment the present invention includes a natural language processing (NLP) server configured for processing captured data based on NLP model.

In an embodiment the at least one memory of the present invention has pre-fed intelligence to process data.

In an embodiment, the present invention provides a computer-readable non-transitory storage medium storing executable program instructions for managing data in Internet of Things (IOT) networks which when executed by a computer cause the computer to perform operations as described above. In a related aspect, embodiments described herein that are implemented as a non-transitory storage medium stores data and/or information, such as instructions, program code, data structures, program modules, an application, etc. A non-transitory storage medium includes one or more of the storage mediums described in relation to memory/storage.

In another embodiment, the computer readable storage medium includes executable program instructions in a memory to be executed for generating data patterns.

In another embodiment, the computer-readable storage medium includes storing instructions that cause the processor to automatically add storage for storing data patterns.

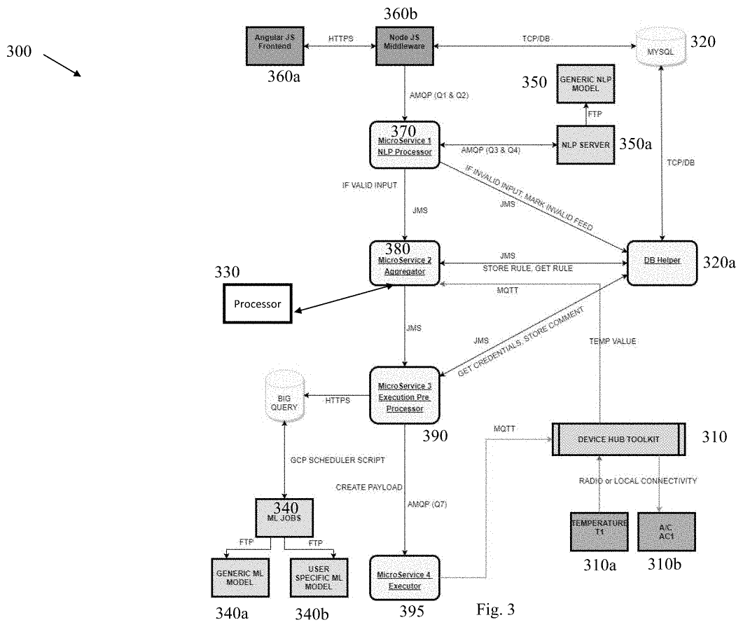

Referring to FIG. 3 a flow diagram with system components configured for executing user instruction of operating air-conditioning in automation environment is shown in accordance with an embodiment of the present invention. The system 300 includes an AngularJS Frontend (360a) that supports both web and mobile frontend, a NodeJS Middleware (360b) that acts as middle interface layer and pass through a communication layer, a NLP Microservice (370) to manage NLP commands and inputs, a NLP Parsing Server (350a) to interpret user commands both in text and voice, a memory 320, a processor 330, an Aggregator Microservice (380) to aggregate multiple activities, a pre-Processor Microservice (390), an Executor Microservice (395), plurality of machine learning Jobs (340) including Generic ML model (340a) and user specific ML model (340b) and a device Hub Toolkit (310) to manage the radio or local connectivity with temperature sensors 310a and AC 310b.

In an exemplary embodiment, the system of the present invention enables access to smart cities services such as waste management, water quality, traffic patterns through connected traffic lights, health of street lights on their streets, or electric vehicle charging docks. The present invention interfaces with multiple IOT solutions and provide a single unified access to all smart services as well provide a unified behavior of usage to the government and municipalities.

In another exemplary embodiment, the system of the present invention enables integration and operation in smart building having multiple applications such as smart parking docks, automated controlled and remote-controlled HVAC systems, solar lights, crowd management in cafeteria, connected elevators, and smart lights. The platform of the present invention enables building admin, maintenance staff and facilities manager to interface with multiple systems and also derive usage behavior and patterns across the board there by adding value to the entire building.

In an exemplary embodiment, the IOT based platform of the present invention enables to monitor critical parameters in the farm such as soil moisture, soil quality, PH level, health of the farm, tractors and other equipment. It enables farmer or owner to monitor these parameters remotely through a single interface and help improve the yield through analytics.

In an embodiment, the present invention is implemented over cloud platform. Cloud platform may include network devices, computing devices, and other equipment to provide over-the top services, including services for customers with IOT devices. In one implementation, cloud platform may include components for authentication and provisioning, device profiles, a rules engine, and messaging.

In some implementations, the machine learning model is configured and trained to detect and/or predict the actions of only a single object or single class of objects. For example, output generated over the model may provide an indication of whether a particular object or class of objects is present, and optionally user instructions. In some implementations, the machine learning model is configured and trained to detect and/or predict the behavior of multiple objects or multiple classes of objects. Accordingly, in those implementations a single pass over a single machine learning model may be utilized to detect whether each of multiple objects is present and/or to predict poses of those present object(s). For example, output generated over the model may provide an indication of whether a first particular object or class of objects is present, and indication of whether a second particular object or class of object is present, etc.—and optionally performance for one or more of the particular objects or classes indicated to be present.

In an exemplary embodiment, to tackle data privacy and security policies for ensuring user's PII (personal identifiable information) is not stored, mechanisms like progressive neural networks are used. The mechanism transfers learning without forgetting prior knowledge but without the need of using stored data. It trains the neural network on the available data without using the historic data and therefore the user's personalization patterns are retained, and recommendation are generated but the PII and any sensitive data (as selected by the user in the application) is safely deleted.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

The word “exemplary” is used herein to mean “serving as an example.” Any embodiment or implementation described as “exemplary” is not necessarily to be construed as preferred or advantageous over other embodiments or implementations.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

Each of the above identified processes corresponds to a set of instructions for performing a function described above. The above identified programs or sets of instructions need not be implemented as separate software programs, procedures or modules, and thus various subsets of these modules may be combined or otherwise re-arranged in various embodiments. For example, embodiments may be constructed in which steps are performed in an order different than illustrated, steps are combined, or steps are performed simultaneously, even though shown as sequential steps in illustrative embodiments. Also, the terminology used herein is for the purpose of description and should not be regarded as limiting. The use of “including,” “comprising,” “having,” “containing” and variations thereof herein, is meant to encompass the items listed thereafter and equivalents thereof as well as additional items.

The above-described embodiments of the present invention may be implemented in any of numerous ways. For example, the embodiments may be implemented using various combinations of hardware and software and communication protocol(s). Any standard communication or network protocol may be used and more than one protocol may be utilized. For the portion implemented in software, the software code may be executed on any suitable processor or collection of processors, whether provided in a single computer or distributed among multiple computers. Such processors may be implemented as integrated circuits, with one or more processors in an integrated circuit component, or any other suitable circuitry. Further, it should be appreciated that a computer may be embodied in any of a number of forms, such as a rack-mounted computer, a desktop computer, a laptop computer, single board computer, micro-computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, the various methods or processes outlined herein may be coded as software that is executable on one or more processors that employ any one of a variety of operating systems or platforms. Additionally, such software may be written using any of a number of suitable programming languages and/or programming or scripting tools or a combination of programming languages, and also may be compiled as executable machine language code or intermediate code that is executed on a framework or a virtual machine. In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form.

The terms “program” or “software” are used herein in a generic sense to refer to any type of computer code or set of computer-executable instructions that may be employed to program a computer or other processor to implement various aspects of the present invention as discussed above. Additionally, it should be appreciated that according to one aspect of this embodiment, one or more computer programs that when executed perform methods of the present invention need not reside on a single computer or processor but may be distributed in a modular fashion amongst a number of different computers or processors to implement various aspects of the present invention. Computer-executable instructions may be in many forms, such as program modules, executed by one or more computers or other devices. Also, data structures may be stored in computer-readable media in any suitable form. Any suitable mechanism may be used to establish a relationship between information in fields of a data structure, including the use of pointers, tags, or other mechanisms that establish relationship between data elements.

It is to be understood that the above-described embodiments are only illustrative of the application of the principles of the present invention. The illustrative discussions above are not intended to be exhaustive or to limit the invention to the precise forms disclosed. Various modifications and alternative applications may be devised by those skilled in the art in view of the above teachings and without departing from the spirit and scope of the present invention and the following claims are intended to cover such modifications, applications, and embodiments.

1. A method for managing data in IOT networks or applications, the method comprises the steps of:
creating a user interface configured to communicate through applications associated with multiple IOT devices;
in response to receiving instructions for analysis of data, collating data from across the multiple IOT devices, and
deriving a plurality of data patterns wherein a plurality of machine learning models and natural language processing (NLP) models enable generation of data patterns using a cognitive artificial intelligence engine thereby providing recommendation to a user based on the data patterns.

2. The method of claim 1 further comprises storing a set of rules or protocols in a memory to be executed for generating data patterns.

3. The method of claim 2 further comprises analyzing a user behavior data.

4. The method of claim 1 further comprises operating multiple IOT devices based on user instructions.

5. The method of claim 3 wherein the cognitive AI engine uses neural networks to learn a user's behavior and extract the data patterns wherein the data patterns are further used for personification.

6. A system for managing data in multiple IOT networks or applications, the system comprises:
a plurality of IOT devices configured for data capture and communication;
a network interface configured to communicate with one or more remote systems in communication with the plurality of IOT devices;
at least one controller in communication with the plurality of IOT devices for controlling and managing the captured data;
at least one memory to store instructions or rules or protocols, and
at least one processor configured to execute instructions based on the stored rules wherein the processor is associated with a cognitive artificial intelligence engine configured for collating the captured data from the plurality of IOT devices to generate data patterns based on machine learning models and natural language processing (NLP) models.

7. The system of claim 6 wherein the cognitive AI engine is a recommendation engine configured to analyze user behavior based on data gathered from the multiple IOT devices and provide recommendation to end user for next actions.

8. The system of claim 6 further comprises a user interface configured for interacting with multiple IOT devices through a single layer application.

9. The system of claim 6 further comprises a natural language processing (NLP) server having NLP engine configured for processing captured data based on the NLP model.

10. The system of claim 6 wherein the at least one memory has pre-fed intelligence to process data.

11. A computer-readable non-transitory storage medium storing executable program instructions for managing data in Internet of Things (IOT) networks which when executed by a computer cause the computer to perform operations comprising:
creating a user interface configured to communicate through applications associated with multiple IOT devices;
in response to receiving instructions for analysis of data, collating data from across the multiple IOT devices using a cognitive artificial intelligence engine, and
deriving a plurality of data patterns wherein a plurality of machine learning models and natural language processing (NLP) models enable generation of data patterns using an artificial intelligence engine thereby providing recommendation to a user based on the data patterns.

12. The computer-readable storage medium of claim 11 further comprises executable program instructions in a memory to be executed for generating data patterns.

13. The computer-readable storage medium of claim 11 further storing instructions that cause the processor to automatically add storage for storing data patterns.

14. A method for personification of IOT devices interfaced to operate with a single platform, the method comprises:
collating data captured by multiple IOT devices;
learning a user behavior through the collated data using neural networks, and
deriving a plurality of data patterns for personification of IOT devices wherein a plurality of machine learning models and natural language processing (NLP) models enable generation of data patterns using a cognitive artificial intelligence engine thereby providing recommendation to a user based on the data patterns.

15. The method of claim 14 wherein the single platform enables generation of data patterns for personification of IOT devices operating with incompatible applications.

16. The method of claim 14 wherein the cognitive AI engine is a self-learning engine that generates data patterns based on analysis of user behavior for recommending actions.
